(19) United States
(12) Patent Application Publication
(10) Pub. No.: US 2011/0088718 A1
(43) Pub. Date: Apr. 21, 2011

(54) CHAMBER CLEANING METHODS USING FLUORINE CONTAINING CLEANING COMPOUNDS

(75) Inventors: Robert Torres, JR., Parker, CO (US); Carrie L. Wyse, Longmont, CO (US)

(73) Assignee: Matheson Tri-Gas, Inc., Basking Ridge, NJ (US)

(21) Appl. No.: 12/904,818

(22) Filed: Oct. 14, 2010

Related U.S. Application Data
(60) Provisional application No. 61/252,366, filed on Oct. 16, 2009.

(51) Int. Cl. B08B 7/00

(52) U.S. Cl. 134/1.1

(57) ABSTRACT

Methods of cleaning a process chamber used to fabricate electronics components are described. The methods may include the step of providing a cleaning gas mixture to the process chamber, where the cleaning gas mixture may include a fluorine-containing precursor, and where the cleaning gas mixture removes contaminants from interior surfaces of the processing chamber that are exposed to the cleaning gas mixture. The methods may also include the steps of removing the reaction products of the cleaning gas mixture from the process chamber, and providing a substrate to the process chamber following the evacuation of the reaction products from the process chamber. The cleaning gas mixture may include one or more hydrofluoronated ethers, and the contaminants may include one or more tin-containing contaminants.

### CROSS REFERENCE TO RELATED APPLICATION

This application is a nonprovisional of, and claims the benefit of the filing date of, U.S. Prov. Application No. 61/252,366, entitled “CHAMBER CLEANING METHODS USING FLUORINE CONTAINING CLEANING COMPOUNDS,” filed Oct. 16, 2009, the entire disclosure of which is incorporated herein by reference for all purposes.

### BACKGROUND OF THE INVENTION

The manufacturing of electronics components such as semiconductor integrated circuit chips, photovoltaic panels, flat panel display screens, organic light-emitting-diode arrays, etc., typically involves the introduction of a substrate (e.g., a semiconductor wafer) in a process chamber that may for example deposit, dope, pattern, planarize and/or etch the substrate. The process steps also typically involve the introduction of gases into the process chamber, and may further involve the activation of those gases by thermal, plasma, and/or chemical reaction mechanisms. The goal is to have the process gases, intermediates, and reaction products stay confined to the substrate or exit the chamber exhaust, but more typically these gases and their activated species form contaminants on exposed surfaces of the process chamber.

One example is the process chamber contamination that forms during fluorine doping in the fabrication of fluorine-doped metal-oxide films like fluorine-doped tin-oxide used in the fabrication of transparent conducting oxide (TCO) layers in solar PV cells. These fluorine-doped films may be deposited by chemical vapor deposition using one or more activated process gases that include the fluorine, the desired metal, and the oxygen. During the CVD deposition, the process chamber's walls and internal components become coated with fluorine-containing contaminants and metal-oxide contaminants, that can have detrimental effects on temperature control of the substrate in the chamber and the purity of the process substrates. Thus, periodic cleaning of the process chamber is required to maintain a stable and reproducible deposition process.

Presently, these cleaning processes can involve dismantling the chamber to gain physical access to the contaminated surfaces. These surfaces are cleaned by a combination of mechanical scrubbing and washing/rinsing with hazardous chemicals. Not only is this clean process physically demanding and dangerous, it requires significant down-time for the disassembly and reassembly of the chamber that significantly reduces the productivity of the process equipment. Moreover, the hazardous chemicals must be stored, recycled and/or disposed with great care and expense.

New cleaning methods are desired that reduce the time, labor, danger, and hazardous waste stream needed to clean process chambers and other equipment involved in the fabrication of electronics components. This and other problems are addressed in the present application.

### BRIEF SUMMARY OF THE INVENTION

Methods of cleaning electronics fabrication equipment with cleaning gas mixtures that include fluorine-containing compounds are described. The fluorine-containing compounds/precursors may be selected to reduce the rate of contaminant buildup on the fabrication equipment, and/or make the contaminants more amenable to in-situ cleaning processes that do not require equipment disassembly. In addition to fluorine, the compounds may include carbon, oxygen, nitrogen, metals (e.g., tin), and/or other halogens, among other atomic and molecular constituents. One class of fluorine-containing compounds suitable for the described cleaning methods is hydrofluorinated ethers (HFEs).

Embodiments of the invention include methods of cleaning tin-containing contaminants from a process chamber that deposits doped and/or undoped tin-oxide on a substrate. The methods may include the steps of forming the tin-containing contaminants on a surface of the process chamber, where the tin-containing contaminants include doped and/or undoped tin oxide. The methods may also include introducing a cleaning gas mixture comprising at least one hydrofluorinated ether to the contaminated process chamber. The cleaning gas mixture reacts with at least a portion of the tin-containing contaminants to form one or more gas-phase reaction products. The gas-phase reaction products may be evacuated from the process chamber.

Embodiments of the invention may also include methods of cleaning a process chamber used to fabricate electronics components. The methods may include the step of providing a cleaning gas mixture to the process chamber, where the cleaning gas mixture may include a fluorine-containing precursor, and where the cleaning gas mixture removes contaminants from interior surfaces of the processing chamber that are exposed to the cleaning gas mixture. The methods may also include the steps of removing the reaction products of the cleaning gas mixture from the process chamber, and providing a substrate to the process chamber following the evacuation of the reaction products from the process chamber. The contaminants may include fluorine-containing contaminants or metal-oxide containing contaminants, or a combination of fluorine-containing contaminants and metal-oxide containing contaminants.

Embodiments of the invention may also include in-situ cleaning methods to clean a processing chamber used to make an electronics component by chemical vapor deposition of a conductive, doped or undoped metal oxide layer on a substrate. The cleaning methods may include the steps of removing a first substrate having a doped or undoped metal oxide layer from the processing chamber, and providing a cleaning gas mixture to the processing chamber. The cleaning gas mixture removes contaminants from interior surfaces of the processing chamber exposed to the cleaning gas mixture. The methods may further include removing reaction products of the cleaning gas mixture from the processing chamber, and providing a second substrate to the processing chamber. A second doped or undoped metal oxide may be deposited on the second substrate.

Embodiments of the invention may further include methods of cleaning fluorine-containing and/or metal-oxide containing contaminants from process equipment used to fabricate an electronics component. The methods may include the steps of forming the contaminants on a surface of the process equipment exposed to process gases that help form at least a part of the electronics component, and exposing the surface to at cleaning gas mixture that includes at least one hydrofluorinated ether. The methods may further include removing the contaminants from the surface by forming a gas-phase reaction product between the contaminants and a material generated by the hydrofluorinated ether. The contaminants may include fluorine-containing contaminants or metal-oxide containing contaminants, or a combination of fluorine-containing contaminants and metal-oxide containing contaminants.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 shows selected steps in a method of cleaning a process chamber used to fabricate electronics components according to embodiments of the invention;

FIG. 2 shows selected steps in a method for in-situ cleaning of a processing chamber that is used to form a fluorine-doped metal oxide layer on a substrate according to embodiments of the invention;

FIG. 3 shows selected steps in a method of cleaning electronics component processing equipment with a cleaning gas mixture that includes one or more hydrofluorinated ethers (HFEs) according to embodiments of the invention;

FIG. 4 shows a profilometer scan of the interface between a cleaned area and a substantially uncleaned base portions of a tin-oxide layer across a surface of the wafer;

FIG. 5A shows an energy dispersive X-ray Spectroscopy (EDS) plot of the elemental composition of an uncleaned tin-oxide area on a wafer; and

FIG. 5B shows an energy dispersive X-ray Spectroscopy (EDS) plot of the elemental composition of a cleaned tin-oxide area of the wafer surface using the same cleaning gas mixture.

### DETAILED DESCRIPTION OF THE INVENTION

Methods and compounds used to clean equipment exposed to fluorine-containing gases and liquids and/or metal oxide CVD precursor gases and liquids are described. This equipment may include process chambers used to form electronics components such semiconductor chips, photovoltaic (PV) cells, flat panel displays, organic-light emitting diode (OLED) components, etc. The equipment may also include the source and delivery systems used to deliver deposition precursors (e.g., fluorine-dopant precursors, metal-oxide precursors, etc.) to the process chamber.

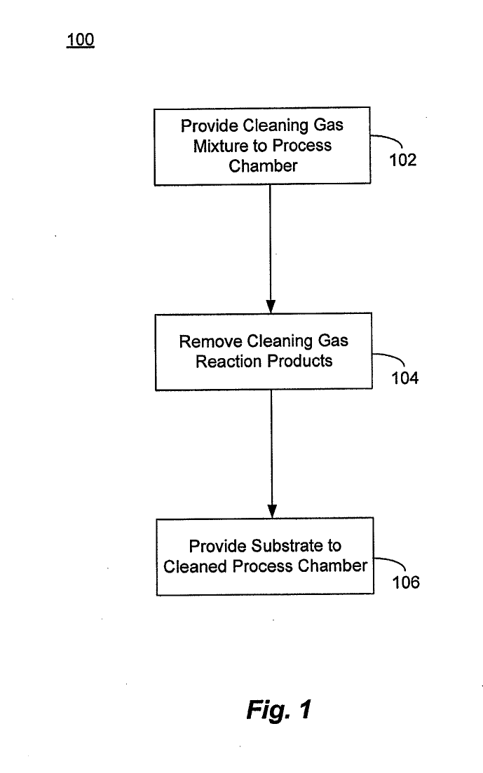

FIG. 1 shows selected steps in methods 100 of cleaning a process chamber used to fabricate electronics components. The methods 100 may include the step of providing a cleaning gas mixture to the process chamber 102. The cleaning gas mixture may include a fluorine-containing precursor that aids in the removal of contaminants from the interior surfaces of the process chamber exposed to the cleaning gas mixture. These fluorine containing precursors react with the contaminants to form reactions products that are sufficiently volatile at the process chamber temperature to form a vapor.

The contaminants may include fluorine-containing contaminants, metal-oxide containing contaminants, and/or combinations of both types of contaminants. The fluorine-containing contaminants may include fluorinated metal-oxide contaminants. The metal-oxide containing contaminants may be doped or undoped, such as antimony and/or zinc doped tin oxide products.

The methods 100 may further include removing the cleaning gas reaction products 104 from the process chamber before providing a substrate to the cleaned process chamber 106 following the removal step. For example, the cleaning gas reaction products may be gases that are removed through an exhaust system from the process chamber.

Examples of the cleaning gas mixture may include one or more fluorine-containing precursors such as hydrofluorinated ethers (HFEs). Many HFEs are relatively high vapor pressure liquids at room temperature that are non-hazardous, have a relatively low impact on global warming, and have low atmospheric lifetimes that make them environmentally advantageous for additional reasons. HFEs can undergo thermal, plasma, and other forms of activation to produce reactive fluorine species capable of reacting, etching, etc., with contaminants in process chamber and supporting equipment. HFEs are capable of performing in-situ cleaning of the process chamber so that the process chamber components can remain assembled and on-line during cleaning. The HFEs may be delivered as part of the gas-phase mixture by bubbling a carrier gas through liquid HFEs in a bubbler apparatus that is in fluid communication with the process chamber. Alternatively, if the HFEs are sufficiently volatile at room temperature (e.g., HFEs with smaller carbon chains or groups), gaseous vapor may be provided directly to the process chamber, either with or without being accompanied by a carrier gas and/or additional components of the cleaning gas mixture.

Embodiments of HFEs include compounds of Formula (I):

R₁—O—R₂ (I)

where R₁ and R₂ are independently a C₁-C₄ alkyl group which may have one or more hydrogens (—H) substituted with fluorine (—F) groups. When either R₁ or R₂ is an unsubstituted alkyl group with no fluorine groups, then the other group R₁ or R₂ has at least one hydrogen substituted with a fluorine group. Specific examples of HFEs include C₄F₉OCH₃, C₄F₉OC₂H₅, CF₃OCH₃, CHF₂OCHF₂, CF₃CF₂OCH₃, CF₃OCHFCF₃, and CF₃COCBr₂H, among others.

HFEs used as fluorine-containing precursors in the clean gas mixture may also include compounds having the formula:

R_{f}OR, where R groups are alkyl chains, and R_{f} groups are fluorinated alkyl groups;

R_{f}OR_{f}, where R_{f} groups are fluorinated alkyl groups;

R_{f}OCH₃, where R_{f} groups are fluorinated moieties with more than 4 carbons;

R_{f}OC₂H₅, where R_{f} groups are fluorinated moieties with more than 4 carbons.

Additional specific examples of HFEs include HFE-7100 (C₄F₉OCH₃); mixtures of (CF₃)₂CFCF₂OCF₃ and CF₃CF₂CF₂CF₂OCH₃; HFE-7200 (C₄F₉OC₂H₅); CH₃OCF₃; CF₂HOCF₃; CF₃CFHOCF₃; CF₃CH₂OCF₃; CF₃CH₂OCHF₂; CF₃CF₂OCH₃; C₄F₉OCH₃; C₄F₉OC₂H₅; and C₃F₇OCH₃.

Additional examples of fluorine-containing precursors may include one or more multihalides, such as ClF, BrF, ClF₂N, FCl₂N, NF₃, NClF₂, BrF₃, CBrF₃, BrF₅, ClBrF₂, IBr₂F₃, ClBr₂F₃, IF, F₂, and IF₅, among others. Fluorine-containing precursors may also include HF, C₂BrF₃, CF₄, CF₂O, CHClF₂, C₂ClF₅, C₂ClF₃, CClF₃, CBr₂F₂, C₂Br₂F₄, CCl₂F₂, C₂Cl₂F₄, C₂H₃ClF₂, C₂H₄F₂, C₂H₂F₂, CH₂F₂, C₃F₆O, C₂F₆, CH₃F, C₄F₈, C₄F₈O, C₅F₈, F₂O, C₂H₅F, ClFO₃, ClF₃, C₄F₁₀, C₃F₈, SO₂F₂, C₂F₄, N₂F₄, CCl₃F, C₂Cl₃F₃, CHF₃, C₂H₃F, and XeF₂, among others.

The cleaning gas mixture may also include one or more carrier gases to carry fluorine-containing precursors. These carrier gases may include helium, argon, dry nitrogen (N₂), and dry air that has and substantially all the moisture removed, among other carrier gases.

The cleaning gas mixture may also include non-fluorinated, co-solvent precursors such as ketones (e.g., acetone); alcohols (e.g., methanol, ethanol, iso-propyl alcohol, etc.); water; and ethers (e.g., CH₃OCH₃, CH₃CH₂OCH₂CH₃, C₄H₉OCH₃, C₃H₇OCH₃). These co-solvent precursors may be mixed with the fluorine-containing precursor at various relative concentrations, where higher concentrations of co-solvents may be provided to enhance the absorption of the fluorine-containing precursor by contaminant residues in the processing chamber.

The cleaning gas mixture may also include additional compounds that are tailored to increase the reactivity of the fluorine-containing precursor with contaminant residues. For example, the additional compounds may make the cleaning gas mixture more oxidative or reductive depending on the types of contaminant materials accumulating in the equipment. Examples of these optional additional compounds may include O₂, H₂, NH₃, HCl, Br₂, Cl₂, HBr, H₂O, CF₃I, among other additional compounds.

The methods 100 described above may be in-situ (a.k.a. on-line) methods that do not require dismantling for physical access to the process chamber that results in more downtime, labor, and operator safety risk associated with physically handling the chamber equipment. The cleaning methods may be integrated into the fabrication processes performed by the equipment in a variety of ways depending on the desired parameters. For example, the cleaning method could be performed between each deposition to prevent contaminants from accumulating in the process chamber from one deposition to the next. Alternatively, the cleaning method may be performed periodically after a predetermined number of depositions (e.g., about 2, 3, 4, 5, 6, 7, 8, 9, 10, 15, 20, 25, 30, depositions, etc.). Another alternative is to monitor the process chamber for buildup of contaminants and execute the cleaning method when the contaminants exceed a threshold level in the chamber.

In still additional alternatives, the cleaning gas mixture may be compatible with the process step taking place in the process chamber (e.g., a deposition process, a doping process, an etching process, a CMP process, etc.) allowing the execution of the process step and the cleaning method at the same time. For example, in a process step where a fluorine-doped metal-oxide layer is deposited on a substrate a cleaning gas mixture containing HFEs may be introduced during the deposition to clean the process chamber equipment.

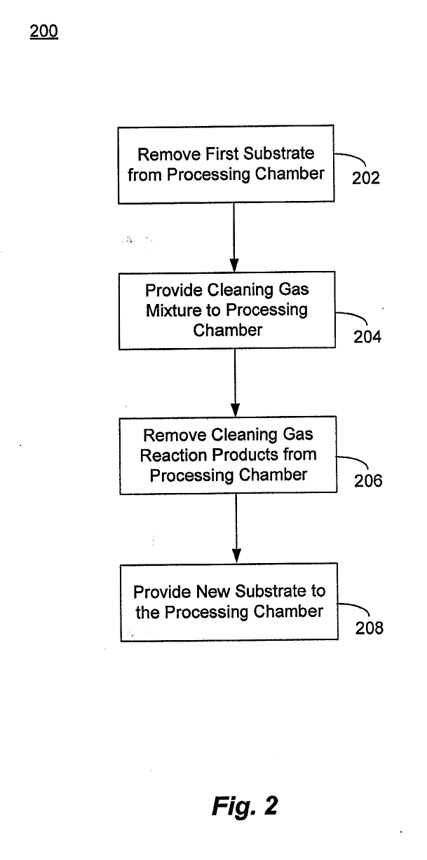

FIG. 2 shows selected steps in a method 200 for in-situ cleaning of a processing chamber that is used to form a fluorine-doped metal oxide layer on a substrate. In-situ cleaning processes may be performed without dismantling the processing chamber and exposing one or more of its component parts to cleaning solutions. Not only does an in-situ process eliminate the time-consuming process of reassembling the components of the process chamber, it also allows better control over the gases introduced to the chamber interior, reducing the degree of passivation and seasoning required to restore the chamber to stable operations.

In-situ cleaning method 200 may include the step of removing a first substrate having a fluorine-doped metal oxide layer from the processing chamber 202. The method 200 may also include providing a cleaning gas mixture to the processing chamber 204. The cleaning gas mixture removes contaminants from the interior surfaces of the processing chamber that have been exposed to the mixture. The contaminants may include fluorine-containing contaminants and/or metal-oxide containing contaminants arising from processes of forming the fluorine-doped metal oxide layer.

The cleaning gas mixture may react with the contaminants to generate reaction products of the cleaning gas mixture. The reactions may be facilitated by the thermal or plasma activation of the cleaning gas mixture. Thermal activation may include adjusting the temperature of the cleaning gas mixture in a chamber to at least a threshold temperature (e.g., at least about 400° C., 500° C., 600° C., etc.) at which one or more components of the cleaning gas mixture react with the contaminants. Plasma activation may include exposing the cleaning gas mixture (or activatable components of the mixture) to a plasma that may be generated either remotely from the processing chamber, or within (in situ) the processing chamber.

The reaction products may be evacuated from the processing chamber 206, before a new substrate is provided to the processing chamber 208. Several fluorine-doped metal-oxide film depositions may occur on a series of substrates before another cleaning gas mixture is supplied to the processing chamber.

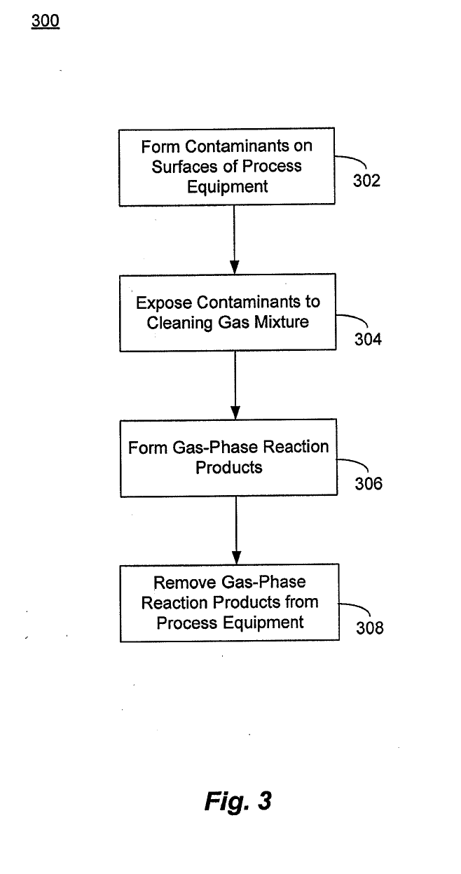

Referring now to FIG. 3, a flowchart of selected steps in a method 300 of cleaning contaminants from process equipment used to fabricate electronics components is shown. The method 300 may include the step of forming the contaminants 302 on a surface of the process equipment exposed to process gases that help form at least a part of the electronics component. The contaminants may be a coating, film layer, residue, etc., that includes fluorine-containing contaminants, metal-oxide contaminants, or combinations of both types of contaminants. For example, the contaminants may include fluorine and tin-oxide-containing contaminants formed on exposed surfaces of the process chamber during the deposition of fluorine-doped tin-oxide layers on a substrate surface that forms part of the electronics component (e.g., a transparent conducting oxide in a solar PV cell).

The contaminants may be exposed to a cleaning gas mixture 304 that contains at least one hydrofluorinated ether like the ones described above. The HFEs may react directly with the contaminants, or they may be activated to form a material that reacts with the contaminants. Activation may involve a thermal, plasma, and/or chemical transformation of the HFE (or the decomposition of the HFE) to produce one or more reactive materials.

The reactive material reacts with the contaminants to form a gas-phase reaction product 306. This product may be removed from the process equipment 308, such as by an exhaust coupled to the equipment. For example, the reaction product may be carried to and through the exhaust with the aid of the cleaning gas mixture and/or a carrier gas. The reaction products may also be carried to and through the exhaust with the aid of a vacuum pump and/or heat simultaneously or in sequential steps. The entire cleaning method may be done in situ without dismantling the process equipment. The cleaning gas mixture may introduced through the same precursor supply system used to introduce deposition, doping, etch gases, etc., to the process equipment.

### EXPERIMENTAL

An experiment is run to measure the etch rate of a tin-oxide (SnO₂) layer with a cleaning gas mixture of ˜30 vol. % CF₃I in argon. The tin-oxide layer is formed on a silicon wafer that has been introduced to the process chamber. The cleaning gas mixture is then introduced to the chamber until reaching a pressure of about 8 Torr while the chamber temperature is set to about 500° C. The reaction between the cleaning gas mixture and the tin-oxide layer on the wafer was run for 2 hours.

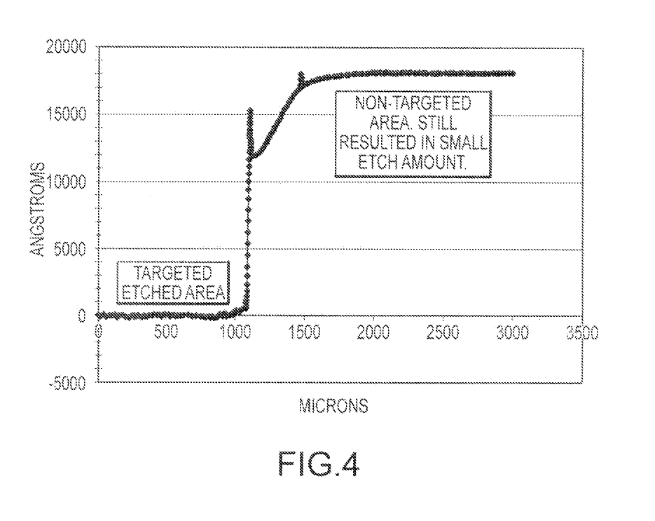

FIG. 4 shows a profilometer scan of the interface between cleaned and uncleaned portions of the tin-oxide layer across the surface of the wafer. The surface profile of the wafer shows an approximately 18,000 Å step at the boundary of the uncleaned portion of the tin-oxide layer indicating the etch rate of the cleaned tin-oxide layer in the cleaning gas mixture averaged at least about 9000 Å/hr.

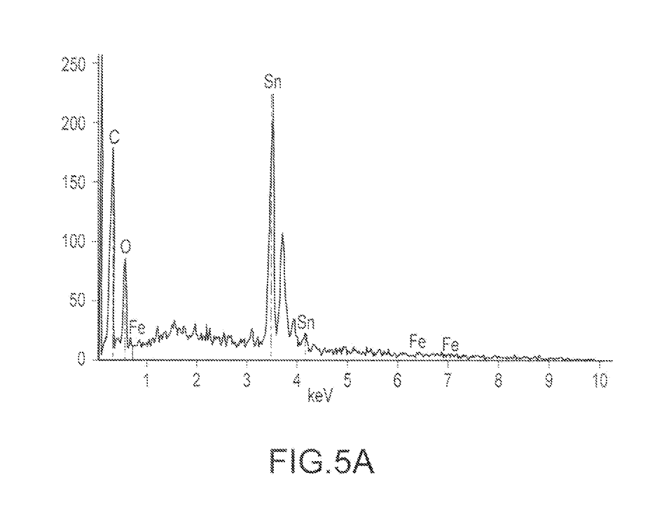

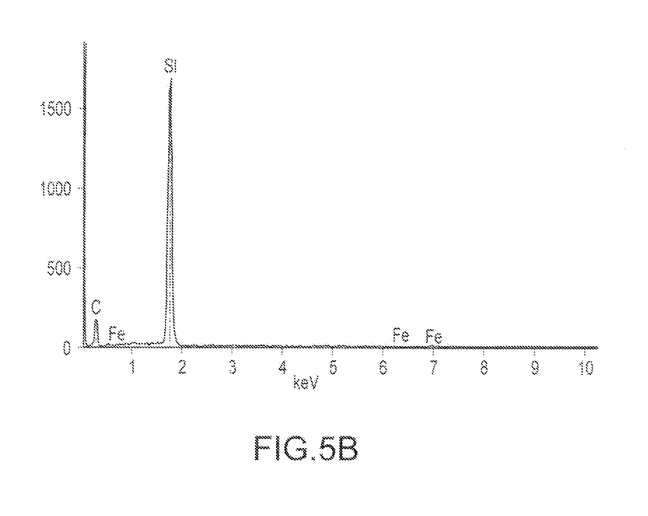

FIGS. 5A&B show energy dispersive X-ray Spectroscopy (EDS) plots of the elemental composition of the wafer surfaces that were uncleaned and cleaned, respectively, to the cleaning gas mixture during the two-hour reaction time. FIG. 5A shows the uncleaned surface still has high levels of tin and oxygen, indicative of the deposited tin oxide layer. FIG. 5B on the other hand shows essentially no detectable tin peak, but a strong silicon peak in that's indicative of silicon substrate on the tin oxide layer. Thus, the cleaning process removed essentially all the SnO₂ layer cleaned by the cleaning gas mixture, while leaving the uncleaned tin-oxide substantially intact.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the precursor” includes reference to one or more precursors and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. An method of cleaning tin-containing contaminants from a process chamber that deposits tin-oxide on a substrate, the method comprising:
forming the tin-containing contaminants on a surface of the process chamber, wherein the tin-containing contaminants comprise tin oxide;
introducing a cleaning gas mixture comprising at least one hydrofluorinated ether to the contaminated process chamber, wherein the cleaning gas mixture reacts with at least a portion of the tin-containing contaminants to form one or more gas-phase reaction products; and
evacuating the gas-phase reaction products from the process chamber.

2. The method of claim 1, wherein the hydrofluorinated ether has the formula:
R₁—O—R₂
where R₁ and R₂ are independently a C₁-C₄ alkyl group which may have one or more hydrogens (—H) substituted with fluorine (—F) groups, and wherein if either R₁ or R₂ is an unsubstituted alkyl group with no fluorine groups, then the other group R₁ or R₂ has at least one hydrogen substituted with a fluorine group.

3. The method of claim 1, wherein the hydrofluorinated ether is selected from the group consisting of C₄F₉OCH₃, C₄F₉OC₂H₅, CF₃OCH₃, CHF₂OCHF₂, CF₃CF₂OCH₃, CF₃OCHFCF₃, and CF₃COCBr₂H.

4. The method of claim 1, wherein the cleaning gas mixture further comprises one or more additional compounds selected from the group consisting of O₂, H₂, NH₃, HCl, Br₂, Cl₂, HBr, H₂O, and CF₃I.

5. An in-situ method of cleaning a process chamber used to fabricate electronics components, the method comprising:
providing a cleaning gas mixture to the process chamber, wherein the cleaning gas mixture comprises a fluorine-containing precursor, and wherein the cleaning gas mixture removes fluorine-containing contaminants or metal-oxide containing contaminants from interior surfaces of the processing chamber that are exposed to the cleaning gas mixture;
removing the reaction products of the cleaning gas mixture from the process chamber; and
providing a substrate to the process chamber following the evacuation of the reaction products from the process chamber.

6. The method of claim 5, wherein the cleaning gas mixture comprises a carrier gas mixed with the fluorine-containing precursor.

7. The method of claim 6, wherein the carrier gas comprises helium, argon, nitrogen, or dry air.

8. The method of claim 5, wherein the contaminants comprise a tin-oxide containing contaminant.

9. The method of claim 5, wherein the fluorine-containing precursor comprises a hydrofluorinated ether.

10. The method of claim 9, wherein the hydrofluorinated ether has the formula:
R₁—O—R₂
where R₁ and R₂ are independently a C₁-C₄ alkyl group which may have one or more hydrogens (—H) substituted with fluorine (—F) groups, and wherein if either R₁ or R₂ is an unsubstituted alkyl group with no fluorine groups, then the other group R₁ or R₂ has at least one hydrogen substituted with a fluorine group.

11. The method of claim 9, wherein the hydrofluorinated ether is selected from the group consisting of C₄F₉OCH₃, C₄F₉OC₂H₅, CF₃OCH₃, CHF₂OCHF₂, CF₃CF₂OCH₃, CF₃OCHFCF₃, and CF₃COCBr₂H.

12. The method of claim 5, wherein the fluorine-containing precursor comprises CF₃I.

13. The method of claim 5, wherein the cleaning gas mixture comprises a co-solvent precursor mixed with the fluorine-containing precursor.

14. The method of claim 13, wherein the co-solvent precursor is selected from the group consisting of a ketone, an alcohol, water, and an ether.

15. The method of claim 14, wherein the ketone is acetone.

16. The method of claim 14, wherein the alcohol comprises methanol, ethanol, or iso-propyl alcohol.

17. The method of claim 14, wherein the ether comprises CH₃OCH₃, CH₃CH₂OCH₂CH₃, C₄H₉OCH₃, or C₃H₇OCH₃.

18. An in-situ cleaning method to clean a processing chamber for a chemical vapor deposition of a conductive fluorine-doped metal oxide layer on a substrate, the method comprising:
removing a first substrate having a fluorine-doped metal oxide layer from the processing chamber;
providing a cleaning gas mixture to the processing chamber, wherein the cleaning gas mixture removes deposition contaminants from interior surfaces of the processing chamber exposed to the cleaning gas mixture;
removing reaction products of the cleaning gas mixture from the processing chamber; and
providing a second substrate to the processing chamber, wherein a second fluorine-doped metal oxide is deposited on the second substrate.

19. The method of claim 18, wherein a plurality of substrates are processed by the processing chamber before providing the chamber with a second cleaning gas mixture.

20. The method of claim 18, wherein the deposition contaminants comprise fluorine-containing contaminants, metal oxide contaminants, or a combination of fluorine-containing contaminants and metal oxide containing contaminants.

21. The method of claim 18, wherein the conductive fluorine-doped metal oxide layer comprises a fluorine-doped tin-oxide layer, and the deposition contaminants comprise tin-oxide contaminants.

22. The method of claim 18, wherein the cleaning gas mixture comprises one or more hydrofluorinated ethers.

23. The method of claim 18, wherein the cleaning gas mixture comprises CF₃I.
